(19) United States
(12) Patent Application Publication
(10) Pub. No.: US 2007/0154049 A1
(43) Pub. Date: Jul. 5, 2007

(54) Transducer, headphone and method for reducing noise

(76) Inventors: Igor Levitsky, Richmond Hill (CA); Konstantin Baklaev, Lviv (UA)

Correspondence Address: PATENTS+TMS;A Professional Corporation, 2849 W. Armitage Ave., Chicago, IL, 60647, US

(21) Appl. No.: 11/325,701

(22) Filed: Jan. 5, 2006

(51) Int. Cl. H04R 25/00

(52) U.S. Cl. 381/371; 381/370

(57) ABSTRACT

A transducer, a headphone and a method reduce noise and/or ambient sounds. The headphone has a microphone, a transducer and/or an electrical circuit for producing and/or for transmitting an anti-noise sound wave and/or a noise compensation signal inside an ear cup of the headphone. The anti-noise sound wave and/or the noise compensation signal cancels, dampens and/or reduces a sound wave of the noise and/or of the ambient sounds inside the ear cup. The transducer produces and/or transmits an audio signal which is received by an ear of a user. The microphone and the transducer are connected to, are attached to and/or are in communication with the electrical circuit within the headphone. The transducer has a double-sided diaphragm with concentric circular corrugations and/or foil spiral conductors on each side of the diaphragm. The microphone inside the ear cup is covered by and/or is connected to a sound absorbing material inside the ear cup of the headphone. An ear cushion having a inner side and an outer side is attached to and/or is connected to the ear cup for receiving an ear of a user. The inner side and the outer side of the ear cushion are made from an acoustically resistive material and an acoustically isolating material.

### BACKGROUND OF THE INVENTION

The present invention generally relates to a transducer, a headphone and a method for reducing noise. More specifically, the present invention relates to a transducer, a headphone and a method for reducing noise and/or ambient sounds heard by an ear of a user in a high noise environment. The headphone may have a transducer which may be mounted inside an ear cup of the headphone. The transducer may have a diaphragm which may be made from a plastic film and metal foil conductors having concentric circular corrugations. A spiral pattern of a first side and/or of a second side of the diaphragm may provide spacing or gaps between the metal foil conductors of the first side and the second side. The spacing or the gaps of the first side may not coincide with, may not correspond to and/or may not align with spacing or the gaps of the second side to provide an uninterrupted metal foil on at least the first side or the second side of the diaphragm. The spiral pattern of the first side may not coincide with, may not correspond to and/or may not align with the spiral pattern of the second side.

An electrical circuit may be connected to, may be attached and/or may be in communication with the microphone and/or the transducer for signal amplification, noise cancellation and/or noise reduction inside the ear cup of the headphone. A sound absorbing material and/or a damping material may be attached to the microphone for reducing noise received by the ear of the user via the headphone. An ear cushion of the headphone may be connected to the ear cup for attaching and/or for connecting the headphone to the ear of the user. The ear cushion may be made from an acoustically isolating material and/or an acoustically resistive material. Alternatively, the transducer may not be connected to the electrical circuit to produce, to generate and/or to transmit an audio signal which may be received by and/or may be heard by the ear of the user.

It is generally known that, for example, an ear cup of a headphone may have a microphone, a transducer and/or an electric circuit to produce an audio signal for canceling, for damping and/or for reducing noise and/or ambient sounds from a source which is exterior to the headphone. The microphone determines and/or identifies a sound wave of the noise and/or of the ambient sounds transmitted from the source to an ear drum of a user of the headphone. The microphone, the transducer and/or the electric circuit produces, transmits and/or generates an anti-noise sound wave which is the opposite polarity from a sound wave of the noise and/or the ambient sounds. The microphone and/or the transducer transmits the anti-noise sound wave into the ear cup of the headphone to interfere with, to cancel, to dampen and/or to reduce the sound wave of the noise and/or the ambient sounds within the ear cup. As a result, the noise and/or the ambient sounds inside the ear cup is canceled, is dampened and/or is reduced to prevent the ear drum of the user of the headphone from hearing and/or from receiving the sound wave of the noise and/or the ambient sounds.

The user may listen to, may receive and may consume an audio signal from an electric device via the headphone. The anti-noise sound wave from the microphone and/or the transducer may be used to cancel, to dampen and/or to reduce the noise and/or the ambient sounds from the source as the user listens to, receives and/or consumes the audio signal. As a result, the user may not be required to increase a volume of the electric device to hear, to receive and/or to consume the audio signal as a volume and/or an intensity of the noise and/or the ambient sounds may be increased by the source. The microphone, the transducer and/or the electrical circuit only cancels and/or reduces noise and/or ambient sounds at lower frequencies.

Traditionally, the transducer of the headphone is an electro-dynamic transducer. The electro-dynamic transducer has a diaphragm with a high acoustical impedance which reduces stability of the headphone for canceling, for dampening and/or for reducing the noise and/or the ambient sounds heard by the ear drum via the headphone. Further, the electro-dynamic transducer may not have a resonance frequency below two hundred Hertz (hereinafter “Hz”) because producing an electro-dynamic transducer with such a low resonance frequency is impractical and/or is difficult. Moreover, the electro-dynamic transducer has a thickness in a range between twenty-five microns and fifty microns. However, the resonance frequency and the thickness of the electro-dynamic transducer reduces capabilities of the headphone to cancel, to dampen and/or to reduce the sound wave of the noise and/or of the ambient sounds between the ear cup of the headphone and the ear drum of the user. As a result, the headphone may be ineffective for canceling, for dampening and/or for reducing the noise and/or the ambient sounds received by and/or heard by the ear drum of the user.

A need, therefore, exists for a transducer, a headphone and a method for reducing noise. Additionally, a need exists for a transducer, a headphone and a method for reducing noise which may transmit an anti-noise sound wave and/or a noise compensation signal into an ear cup of the headphone to cancel, to dampen and/or to reduce a sound wave of noise and/or of ambient sounds from an exterior source. Further, a need exists for a transducer, a headphone and a method for reducing noise which may provide a diaphragm of a transducer with a resonance frequency below two hundred Hz. Still further, a need exists for a transducer, a headphone and a method for reducing noise which may provide a planar ribbon transducer for reducing noise and/or ambient sounds in an ear cup of the headphone. Moreover, a need exists for a transducer, a headphone and a method for reducing noise which may provide sound absorbing material, sound isolating material and/or sound resistive material attachable to a microphone of and/or to an ear cup of the headphone to reduce, to cancel and/or to dampen the noise and/or ambient sounds. Furthermore, a need exists for a transducer, a headphone and a method for reducing noise which may provide more than one transducer in the headphone to prevent the noise and/or ambient sounds of an exterior source from being heard by and/or from being received by an ear drum of a user.

### SUMMARY OF THE INVENTION

The present invention generally relates to a transducer, a headphone and a method for reducing noise. More specifically, the present invention relates to a transducer, a headphone and a method for reducing noise which may have a microphone, a transducer and/or an electrical circuit for producing and/or for transmitting an anti-noise sound wave and/or a noise compensation signal inside an ear cup of the headphone to cancel, to dampen and/or to reduce a sound wave of the noise and/or ambient sounds. The microphone and/or the transducer may be connected to, may be attached to and/or may be in communication with the electrical circuit. The transducer may be, for example, a ribbon planar transducer having a double-sided diaphragm with a plastic film, concentric circular corrugations and/or foil spiral conductors on each side. The microphone inside the ear cup may be covered by and/or may be connected to a sound absorbing material inside the ear cup of the headphone. An ear cushion having an inner side and an outer side may be attached to and/or may be connected to the ear cup for attaching and/or for connecting the headphone to an ear of a user. The inner side and/or the outer side of the ear cushion may be made from an acoustically resistive material and/or an acoustically isolating material, respectively.

In an embodiment of the present invention, a transducer for reducing a noise in a cavity of an ear cup of a headphone wherein. the transducer is connected to the headphone wherein the transducer extends inward with respect to the cavity of the ear cup wherein the headphone is attachable to an ear of a user is provided. The transducer has a cap having walls defining an interior of the cap. Further, the transducer has a diaphragm having a first side and a second side wherein the first side is opposite to the second side of the diaphragm wherein the first side has first conductors in a first spiral pattern. Further, the first side has first gaps between the first conductors wherein the second side has second conductors in a second spiral pattern wherein the second side has second gaps between the second conductors. Moreover, the first gaps of the first side do not coincide with the second gaps of the second side wherein the diaphragm is inserted into the interior of the cap wherein an audio signal is transmitted by the transducer wherein the audio signal reduces the noise.

In an embodiment, the first side or the second side of the diaphragm has a thickness less than twenty-five microns.

In an embodiment, the diaphragm has a resonant frequency less than two hundred Hertz.

In an embodiment, the diaphragm is planar.

In an embodiment, the transducer has circular corrugations formed in the first side and the second side of the diaphragm wherein the circular corrugations are located concentrically on the diaphragm and further wherein the circular corrugations have more than one radii.

In an embodiment, the transducer has an ultrasonic weld located between the first side of the diaphragm and the second side of the diaphragm wherein the first side is connected to the second side via the ultrasonic weld.

In another embodiment of the present invention, a headphone for reducing a noise transmitted from a source remote with respect to the headphone wherein a sound wave corresponds to the noise is provided. The headphone has an ear cup having walls defining a cavity wherein the ear cup is sized to receive an ear of a user wherein the ear of the user is insertable into the ear cup. Further, the headphone has a microphone connected to the ear cup wherein the microphone is located within the cavity of the ear cup. Moreover, the headphone has a cover connected to the microphone wherein the cover is located between the microphone and the cavity of the ear cup wherein the cover is an acoustic filter to the microphone wherein the microphone identifies the sound wave of the noise inside the cavity of the ear cup. Furthermore, the headphone has a first transducer connected to the ear cup wherein the first transducer is connected to the microphone wherein the first transducer transmits an audio signal into the cavity of the ear cup wherein the noise in the cavity is reduced by the audio signal.

In an embodiment, the headphone has an ear cushion attached to the walls of the ear cup wherein the ear cup is retained to the ear of the user via the ear cushion and further wherein the ear cushion is made from an acoustically isolating material and an acoustically resistive material.

In an embodiment, the headphone has an electrical circuit located within the ear cup wherein the electrical circuit connects the first transducer and the microphone wherein the electrical circuit identifies the audio signal for reducing the noise.

In an embodiment, the headphone has a second transducer connected to the ear cup wherein the second transducer extends inward with respect to the cavity of the ear cup wherein the second transducer is connected to the first transducer and the microphone.

In an embodiment, the audio signal from the transducer has a polarity which is opposite to the sound wave of the noise.

In an embodiment, the transducer is a planar ribbon transducer.

In an embodiment, the headphone has a diaphragm having circular corrugations wherein the diaphragm is located inside the first transducer.

In another embodiment of the present invention, a method for reducing a noise wherein the noise is transmitted from a source which is remote with respect to an ear of a user wherein a sound wave corresponds to the noise is provided. The method has the step of providing a headphone sized to receive the ear of the user wherein the headphone has walls defining a cavity wherein a planar ribbon transducer is connected to the headphone wherein the planar ribbon transducer wherein the planar ribbon transducer has a diaphragm. Further, the method has the steps of identifying the sound wave of the noise and transmitting an anti-noise sound wave into the cavity of the headphone via the planar ribbon transducer wherein the anti-noise sound wave has a polarity which is opposite to the sound wave of the noise.

In an embodiment, the method has the step of canceling the noise via the anti-noise sound wave.

In an embodiment, the method has the step of inserting the ear of the user into the headphone wherein the cavity of the headphone is adjacent to the ear of the user.

In an embodiment, the method has the step of connecting an electrical circuit to the planar ribbon transducer wherein the electrical circuit determines the anti-noise sound wave.

In an embodiment, the method has the step of forming a spiral pattern on a side of the diaphragm of the planar ribbon transducer.

In an embodiment, the method has the step of attaching a microphone to the ear cup of the headphone wherein the microphone receives the sound wave of the noise.

In an embodiment, the method has the step of transmitting an audio sound to the ear of the user via the transducer of the headphone.

In another embodiment of the present invention, a headphone for reducing a noise transmitted from a source wherein the source is remote with respect to the headphone wherein a sound wave corresponds to the noise is provided. The headphone has an ear cup having walls defining a cavity wherein the ear cup is sized to receive an ear of a user wherein the noise is transmitted into the cavity of the ear cup. Further, the headphone has means for identifying the sound wave of the noise wherein the means for identifying the sound wave connects to the ear cup. Moreover, the headphone has means for filtering the sound wave of the noise inside the cavity of the ear cup wherein the means for filtering the sound wave covers the means for identifying the sound wave of the noise. Furthermore, the headphone has means for generating an audio signal within the cavity of the ear cup wherein the means for generating an audio signal is in communication with the means for identifying the sound wave wherein the audio signal reduces the noise.

In an embodiment, the headphone has an electrical circuit connecting the means for identifying the sound wave of the noise to the means for generating the audio signal within the cavity of the ear cup wherein the electrical circuit is located within the ear cup.

In an embodiment, the headphone has means for retaining the ear cup to the ear of the user wherein means for retaining the ear cup is attached to the walls of the ear cup.

In an embodiment, the headphone has an ear cushion attached to the walls of the ear cup wherein the ear cushion is made from an acoustically isolating material and an acoustically resistive material.

In an embodiment, the headphone has a planar ribbon transducer attached to ear cup wherein the planar ribbon transducer is connected to the means for identifying the sound wave of the noise.

In an embodiment, the means for filtering the sound wave of the noise inside the cavity of the ear cup is made from a sound absorbing material.

In an embodiment, the headphone has a diaphragm having circular corrugations wherein the diaphragm is connected to the ear cup and the means for generating an audio signal within the cavity of the ear cup.

It is, therefore, an advantage of the present invention to provide a transducer, a headphone and a method for reducing noise.

Another advantage of the present invention is to provide a transducer, a headphone and a method for reducing noise which may have a microphone, a transducer and/or a electrical circuit inside an ear cup of the headphone to cancel and/or to reduce, to cancel and/or to dampen the noise and/or ambient sounds.

And, another advantage of the present invention is to provide a transducer, a headphone and a method for reducing noise which may have a double-sided ribbon planar transducer inside an ear cup of the headphone to cancel, to dampen and/or to reduce the noise and/or ambient sounds inside the ear cup.

Yet another advantage of the present invention is to provide a transducer, a headphone and a method for reducing noise having a diaphragm made from laminated plastic film and metal foil spiral conductors to reduce, to dampen and/or to cancel the noise and/or ambient sounds inside an ear cup of the headphone.

A further advantage of the present invention is to provide a transducer, a headphone and a method for reducing noise which may produce an anti-noise sound wave and/or a noise compensation signal to cancel a sound wave of noise and/or ambient sounds within an ear cup of the headphone.

Moreover, an advantage of the present invention is to provide a transducer, a headphone and a method for reducing noise which may have a diaphragm with a resonant frequency near one hundred hertz (Hz) and/or a thickness of a first side or of a second side of the diaphragm near twenty-five microns.

Yet another advantage of the present invention is to provide a transducer, a headphone and a method for reducing noise which may have a double-sided diaphragm to prevent break-up resonances for canceling, for dampening and/or for reducing a sound wave of the noise and/or of ambient sounds.

Another advantage of the present invention is to provide a transducer, a headphone and a method for reducing noise which have a diaphragm with circular corrugations to lower a resonance frequency of the diaphragm to less than two hundred Hz.

Yet another advantage of the present invention is to provide a transducer, a headphone and a method for reducing noise which may attach sound absorbing material to a microphone inside of an ear cup of the headphone to cancel, to dampen and/or to reduce a sound wave of the noise and/or of ambient sounds.

A still further advantage of the present invention is to provide a transducer, a headphone and a method for reducing noise which may attach an ear cushion made of an acoustically isolating material and/or of an acoustically resistive material to an ear cup of the headphone for attaching and/or for connecting the ear cup to an ear of a user.

Moreover, an advantage of the present invention is to provide a transducer, a headphone and a method for reducing noise which has a feedback loop and an electronic circuit to produce, to generate and/or to transmit an anti-noise sound wave and/or a noise compensation signal inside an ear cup of the headphone.

And, another advantage of the present invention is to provide a transducer, a headphone and a method for reducing noise which may have a first transducer and a second transducer inside an ear cup of the headphone for transmitting an audio signal to cancel, to dampen and/or to reduce the noise and/or ambient sounds.

Yet another advantage of the present invention is to provide a transducer, a headphone and a method for reducing noise which may have a plastic film of a diaphragm with a thickness less twenty-five microns.

A further advantage of the present invention is to provide a transducer, a headphone and a method for reducing noise which may have a double-sided diaphragm to vibrate uniformly over a surface of the diaphragm for moving in phase with a sound received by and/or transmitted via the diaphragm.

Moreover, an advantage of the present invention is to provide a transducer, a headphone and a method for reducing noise which may have linear acoustical phase characteristics to improve feedback stability of electrical circuit of the headphone.

And, another advantage of the present invention is to provide a transducer, a headphone and a method for reducing noise which may have an ultrasonic weld for attaching and/or for connecting a first side of a diaphragm to a second side of the diaphragm.

Additional features and advantages of the present invention are described in, and will be apparent from, the detailed description of the presently preferred embodiments and from the drawings.

### BRIEF DESCRIPTION OF THE DRAWINGS

FIG. 1 is an exploded perspective view of a transducer for reducing, for dampen and/or for canceling noise and/or ambient sounds in an embodiment of the present invention.

FIG. 2 is a front plan view of a first side of a double-sided diaphragm of the transducer in FIG. 1 in an embodiment of the present invention.

FIG. 3 is a front plan view of both sides of the double-sided diaphragm in FIG. 2 superimposed onto each other in an embodiment of the present invention.

FIG. 4 is an equivalent schematic of a headphone expressed with mechano-acoustical elements based on lump parameters of the headphone in an embodiment of the present invention.

FIG. 5 is a cross-sectional view of a headphone attached to an ear of a user with a block diagram of an electrical circuit of the headphone in an embodiment of the present invention.

FIG. 6 is a cross-sectional view of a headphone attached to an ear of a user with a block diagram of an electrical circuit of the headphone in an embodiment of the present invention.

FIG. 7 is a cross-sectional view of a headphone attached to an ear of a user with a block diagram of an electrical circuit of the headphone in an embodiment of the present invention.

FIG. 8 is a cross-sectional view of a headphone attached to an ear of a user with a block diagram of an electrical circuit of the headphone in an embodiment of the present invention.

### DETAILED DESCRIPTION OF THE PREFERRED EMBODIMENTS

The present invention generally relates to a transducer, a headphone and a method for reducing noise and/or ambient sounds. The headphone may have a transducer and/or a microphone which may be connected to, may be attached to and/or may be in communication with an electronical circuit inside an ear cup of the headphone. The microphone and/or the electronic circuit may determine, may identify and/or may detect a sound wave of the noise and/or of the ambient sounds. The microphone, the transducer and/or the electrical circuit may produce, may generate and/or may transmit an anti-noise sound wave and/or a noise compensation signal inside the ear cup to cancel, to dampen and/or to reduce the sound wave of the noise and/or of the ambient sound. As a result, an ear drum of a user may not hear and/or may not receive the noise and/or the ambient sounds via the headphone. Moreover, the transducer may produce, may generate and/or may transmit an audio signal to be received by the ear drum of the user.

The transducer may have a double-sided diaphragm with concentric circular corrugations and/or spiral conductors on each side of the double-sided diaphragm. The microphone may be covered by, my be attached to and/or may be connected to a sound absorbing material inside the ear cup of the headphone. A ear cushion may be attached to and/or may be connected to the ear cup of the headphone for attaching the headphone to an ear and/or a head of the user. The ear cushion may be made from an acoustically isolating material and/or an acoustically resistive material for reducing, for blocking and/or for damping the noise and/or the ambient sounds.

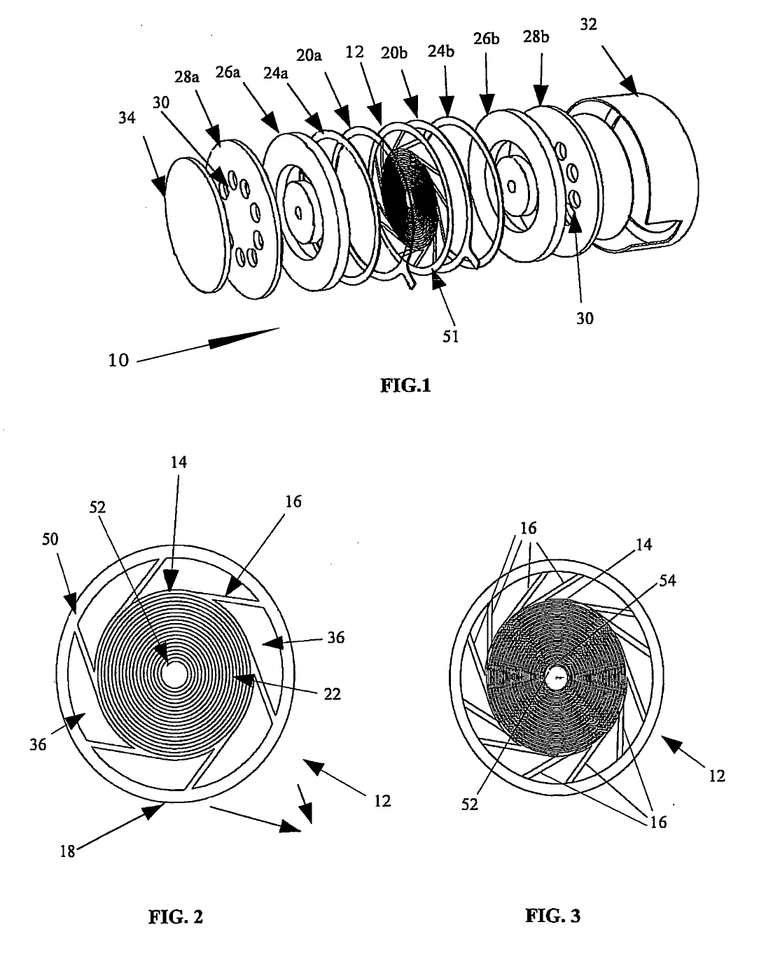

Referring now to the drawings wherein like numerals refer to like parts, FIG. 1 illustrates a transducer 10 which may reduce, may dampen and/or may cancel noise and/or ambient sounds in an embodiment of the present invention. The transducer 10 may be, for example, a ribbon planar transducer and/or the like. The transducer 10 may have a diaphragm 12 which may be, for example, a double-sided diaphragm and/or the like. The diaphragm 12 may have spiral electrical conductors 14, conductor arms 16 and/or an exterior ring 18 as illustrated in FIGS. 2 and 3. The diaphragm 12 may be attached to and/or may be connected to a first ring 20a and a second ring 20b as shown in FIG. 1. As a result, the diaphragm 12 may be located between the first ring 20a and the second ring 20b. The first ring 20a and/or the second ring 20b may be made from a material, such as, for example, metal and/or the like. The present invention should not be deemed as limited to a specific embodiment of the material of the first ring 20a and/or of the second ring 20b. It should be understood that the material of the first ring 20a and/or the second ring 20b may be any material as known to one of ordinary skill in the art.

The spiral electrical conductors 14 of the diaphragm 12 may have circular corrugations 22 which may be located concentrically at more than one radii as shown in FIGS. 2 and 3. A first spacer ring 24a and/or a second spacer ring 24b may be connected to and/or may be attached to the first ring 20a and/or the second ring 20b, respectively. As a result, the first ring 20a, the diaphragm 12 and/or the second ring 20b may be located between the first spacer ring 24a and the second spacer ring 24b. The first spacer ring 24a and/or the second spacer ring 24b may be made from a material, such as, for example, an electrical insulating material, a dielectric material and/or the like. The present invention should not be deemed as limited to a specific embodiment of the material of the first spacing ring 24a and/or the second spacing ring 24b. It should be understood that the material of the first spacing ring 24a and/or the second spacing ring 24b may be any material capable of resisting a flow of electric current as known to one of ordinary skill in the art.

The transducer 10 may have a first magnet 26a, a second magnet 26b, a first outer disk 28a and/or a second outer disk 28b as shown in FIG. 1. The first outer disk 28a and/or the second outer disk 28b may be made from a material, such as, for example, metal and/or the like. The first outer disk 28a and/or the second outer disk 28b may have one or more holes 30 which may extend through the first outer disk 28a and/or the second outer disk 28b, respectively. The first magnet 26a and/or the second magnet 26b may be attached to and/or may be connected to the first outer disk 28a and/or the second outer disk 28b, respectively. The present invention should not be deemed as limited to a specific embodiment of the material of the first outer disk 28a and/or the second outer disk 28b.

The first spacer ring 24a and/or the second spacer ring 24b may be attached to and/or may be connected to the first magnet 26a and/or the second magnet 26b, respectively. As a result, the first spacer ring 24a, the first ring 20a, the diaphragm 12, the second ring 20b and/or the second spacer ring 24b may be located between the first outer ring 28a and/or the first magnet 26a and the second outer ring 28b and/or the second magnet 26b, respectively. The first outer ring 28a and/or the second outer ring 28b may be inserted into, may be attached to and/or may be connected to a cap 32. As a result, the diaphragm 12 may be clamped to, may be attached to, may be connected to and/or may be secured to the cap 32.

A cover 34 may be attached to the first outer ring 28a and/or the cap 32. The cap 32 may be made from a material, such as, for example, metal and/or the like. The cover 34 may be made from a material, such as, for example, an acoustic dampening material, a fibrous material and/or the like. An audio signal may be applied to, may be received by and/or may be transmitted to the diaphragm 12. As a result, the diaphragm 12 may vibrate, may produce, may generate and/or may radiate an audio sound through the holes 30 of the first outer disk 28a and/or the second outer disk 28b. The present invention should not be deemed as limited to a specific embodiment of the material of the cap 32. It should be understood that the material of the cover 34 may be any material having an acoustical dampening characteristic as known to one of ordinary skill in the art.

FIGS. 2 and 3 illustrate the diaphragm 12 of the transducer 10 for reducing, for dampening and/or for canceling the noise and/or the ambient sounds in an embodiment of the present invention. The diaphragm 12 may be, for example, a laminate with a film which may be located between and/or may be covered by, for example, aluminum foil and/or the like. The film may be made from a material, such as, for example, a dielectric plastic material and/or the like. The spiral electrical conductors 14 and/or the circular corrugations 22 may be connected to and/or may be attached to the exterior ring 18 of the diaphragm 12 via the conductor arms 16. As a result, gaps 36 may be formed between the exterior ring 18 and the spiral electrical conductors 14 and/or the circular corrugations 22 of the diaphragm 12 as shown in FIG. 2. It should be understood that the material of the film of the diaphragm 12 may be any material capable of resisting a flow of electric current as known to one of ordinary skill in the art.

The exterior ring 18 of the diaphragm 12 may abut and/or may contact the first ring 20a and/or the second ring 20b. As a result, the diaphragm 12 may be connected to the first ring 20a and/or the second ring 20b. The exterior ring 18 may be made from, for example, the aluminum foil which may contact the first ring 20a and/or the second ring 20b. The circular corrugations 22 and/or the gaps 36 may not have the aluminum foil covering the film of the diaphragm 12. As a result, the film of the diaphragm 12 may be exposed and/or may be uncover in the circular corrugations 22 and/or in the gaps 36 of the diaphragm 12.

The spiral electrical conductors 14 and/or the circular corrugations 22 of the diaphragm 12 may have a first spiral pattern 52 and/or a second spiral patten 54 as shown in FIGS. 2 and 3. The first spiral pattern 52 and/or the second spiral pattern 54 may be formed on the diaphragm 12 by an etching process, such as, for example, a chemical etching process and/or the like. FIG. 2 illustrates the first spiral pattern 52 of the spiral electrical conductors 14 on a first side 50 of the diaphragm 12. FIGS. 1 and 3 illustrate the second spiral pattern 54 of the spiral electrical conductors 14 on the second side 51 of the diaphragm 12. The first side 50 may be attached to and/or may be connected to the second side 51 of the diaphragm 12 via an ultrasonic weld. As a result, the ultrasonic weld may electrically connect the first side 50 to the second side 51 of the diaphragm 12.

The first spiral pattern 52 on the first side 50 of the diaphragm 12 may be superimposed onto the second spiral pattern 54 of the second-side 51 of the diaphragm 12 as shown in FIG. 3. The first spiral pattern 52 on the first side 50 may not coincide with, may not align with and/or may not correspond to the second spiral pattern 54 on the second side 51 of the diaphragm 12. As a result, the gaps 36 between the conductor arms 16 on the first side 50 may not coincide with, may not align with and/or may not correspond to the gaps 36 on the second side 51 of the diaphragm 12. The first side 50 may have the conductor arms 16 which may be connected to and/or may be attached the conductor arms 16 via the ultrasonic weld. The present invention should not be deemed as limited to a specific embodiment of the etching process of the first spiral pattern 52 and/or of the second spiral pattern 54.

The diaphragm 12 may remain planar and/or may remain flat with respect to the cap 32 for producing, for generating and/or for transmitting the audio sound. Further, the diaphragm 12 may stabilize vibrations of the diaphragm 12 for producing, for generating and/or for transmitting the audio sound with the transducer 10. Moreover, the diaphragm 12 may allow the transducer 10 to have a resonant frequency which may be lower than a resonant frequency of an electro-dynamic transducer (not shown in the figures) to stabilize the transducer 10 and/or to extend into low frequencies. Furthermore, the diaphragm 12 may be used in conjunction with transducers (not shown in the figures), such as, for example, loudspeakers, microphones and/or the like. The present invention should not be deemed as limited to a specific embodiment of the transducers.

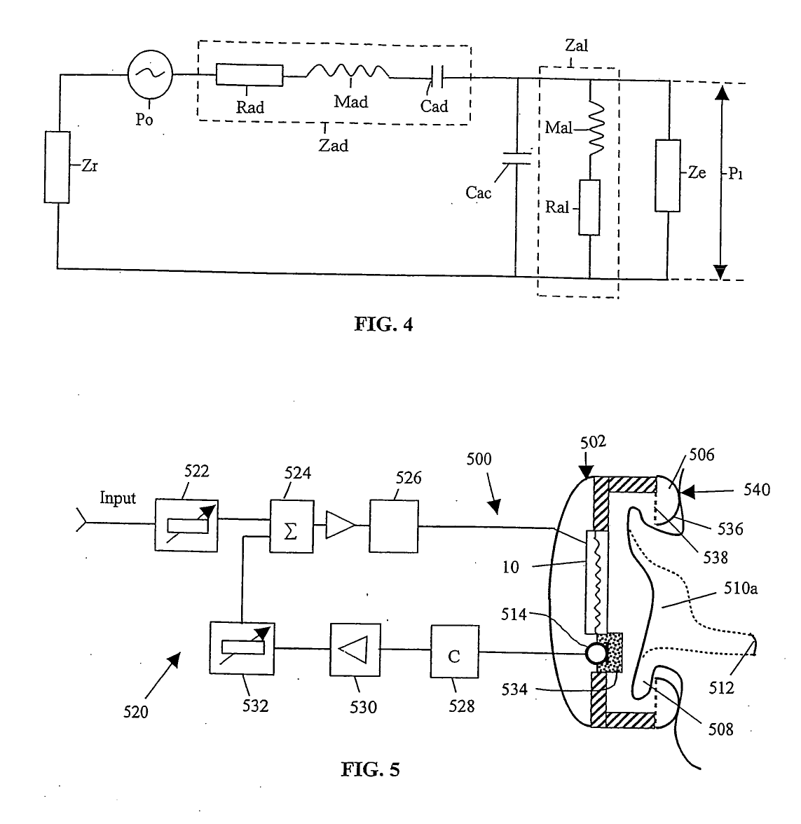

FIG. 4 illustrates an equivalent schematic 400 of a headphone expressed with mechano-acoustical elements based on lump parameters of the headphone in an embodiment of the present invention. The equivalent schematic 400 may be valid for a low frequency band and/or for a mid frequency band between a range of, such as, for example, two kilo-Hertz (hereinafter “kHz”) and three kHz. The equivalent schematic 400 may have an element Zr which may represent air canals (not shown in the figures) and cavities (not shown in the figures) behind the diaphragm 12 of the transducer 10. The equivalent schematic 400 may have an impedance Zad of the diaphragm 12 and/or a compliance Cad of the diaphragm 12 for the transducer 10. Further, the equivalent schematic 400 may have a mass Mad of the diaphragm 12 and/or a resistance Rad of the diaphragm 12 of the transducer 10. Still further, the equivalent schematic 400 may have a compliance Cac of air between an ear drum 512 and the diaphragm 12 of transducer 10 (shown in FIGS. 5-8). Moreover, the equivalent schematic 400 may have a complex impedance Zal which may characterize and/or may represent air leakage between the ear cushion 506 and an ear 508 (shown in FIGS. 5-8).

The equivalent schematic 400 may have a mass Mal of the air leakage, a resistance Ral of the air leakage and/or an input acoustical impedance Ze for the ear 508 as a headphone load. The input acoustical impedance Ze may characterize canals (not shown in the figures) and cavities (not shown in the figures) of the ear 508. The canals and/or the cavities may represent a volume of the external ear (not shown in the figures), an auditory canal (not shown in the figures), an outer ear (not shown in the figures) and/or an eardrum 512. Further, the equivalent schematic 400 may have a sound pressure P1 in the cavity 510 between diaphragm 12 and the eardrum 512. Still further, the equivalent schematic 400 may have an equivalent sound pressure Po of a source (not shown in the figures). As a result, the equivalent schematic 400 may have a transfer function for a headphone-ear system which may be equal to a ratio of the sound pressure P1 over the equivalent sound pressure Po.

Headphones 500, 600, 700, 800 (shown in FIGS. 5-8) may utilize the equivalent schematic 400 having a performance which may be characterized by the sound pressure P1 and a stability of the sound pressure P1. The impedance Zad of the diaphragm 12 may be lowered during manufacturing of the transducer 10 to lessen a sensitivity of the sound pressure P1 to variations of parameters as the air leakage due to a poor or a varying pressure or seal between the ear cup 502 and the ear 508 may be increased. As the impedance Zad of the diaphragm 12 may be lowered, a performance of the headphones 500, 600, 700, 800 may increase a stability of performance parameters of the headphones 500, 600, 700, 800. The mass Mad of the diaphragm 12 may be decreased during a manufacturing of the transducer 10 to lower the impedance Zad of the diaphragm 12. Lowering the impedance Zad may be achieved by lowering the resonance frequency of the diaphragm 12 and/or by increasing the compliance Cad when using the film and/or corrugation of the diaphragm 12.

The transducer 10 may not have a voice coil in a magnetic gap as the electro-dynamic transducer to increase stabilization of the transducer 10 by-reducing occurrences of break-up resonances in the diaphragm 12. The diaphragm 12 may have a thickness between a range, for example, five microns and fifteen microns. The diaphragm 12 may have a flexibility greater than a flexibility a diaphragm of the electro-dynamic transducer since the diaphragm 12 may not have the voice coil which may move outside the magnetic gap and/or may not exhibit contact between the voice coil and the magnetic gap. The diaphragm 12 may not be stiff since a driving force may be distributed uniformly across the diaphragm 12 and/or since the occurrences of the break-up resonances may be absent from the transducer 10. The circular corrugations 22 may allow the resonance frequency of the diaphragm 12 to be in a range between, for example, two hundred Hz and one hundred Hz.

An effectiveness of the headphones 500, 600, 700, 800 to reduce, to dampen and/or to cancel the noise and/or the ambient sounds may rely on, may be based on and/or may correspond to a feedback signal from a microphone 514 (as shown in FIGS. 5-8), respectively. The microphone 514 may transmit a voltage related to, based on and/or corresponding to the sound pressure P1 in the cavity 510 between the ear drum 512 and the transducer 10 and/or the microphone 514. The sound pressure P1 may fluctuate, and the effectiveness of the headphones 500, 600, 700, 800 may become unstable. As a result, the impedance Zad of the diaphragm 12 may be lower to stabilze the effectiveness of the noise reduction by the headphones 500, 600, 700, 800.

The transducer 10 of the headphones 500, 600, 700, 800 may have an electrical impedance (not shown. in the figures) of the diaphragm 10 which may resist the flow of electric current. Further, the transducer 10 may have an inductance (not shown in the figures) which may be lower than an inductance of the electro-dynamic transducer. An electrical phase characteristic of the transducer 10 may be smoother than and/or may be more linear than an electrical phase characteristic of the electro-dynamic transducer. The transducer 10 may have the break-up resonances at upper mid-range frequencies and/or high-range frequencies. The transducer 10 may have a level of break-up diaphragm resonances which may be negligible in comparison with a level of break-up diaphragm resonances of the electro-dynamic transducer. The diaphragm 12 may vibrate within a phase as the diaphragm 12 may be driven uniformly and/or may vibrate uniformly to move in the phase of the diaphragm 12. As a result, a feedback stability of the headphones 500, 600, 700, 800 for reducing, for dampening and/or for canceling the noise and/or the ambient sounds may be increased and/or may be improved by the diaphragm 12 of the transducer 10.

FIG. 5 illustrates the headphone 500 which may be attached to and/or may be connected to the ear 508 of the user (not shown in the figures) in an embodiment of the present invention. The transducer 10 and/or the microphone 514 may be connected to and/or may be attached to the ear cup 502 of the headphone 500 for reducing the noise and/or the ambient sounds. The transducer 10 and/or the microphone 514 may be adjacent to the ear 508 and/or the ear drum 512. The headphone 500 may have the ear cushion 506 which may be attached to and/or connected to the ear cup 502 of the headphone 500. The ear 508 may be inserted, may be located between and/or may be positioned between the ear cushion 506 and the ear cup 502 of the headphone 500. The ear 508 may extend inward with respect to the ear cup 502 to be retained inside the ear cup 502 via the ear cushion 506. The ear cup 502 and/or the ear cushion 506 may be sized to receive the ear 508 for retaining the ear 508 between the ear cup 502 and the ear cushion 506. The headphone 500 may be worn on and/or may be retained to the ear 508 via the ear cushion 506 to form the cavity 510 between the ear drum 512 and the microphone 514, the transducer 10 and/or the ear cup 502.

The headphone 500 may have the microphone 514 and/or the transducer 10 inside the ear cup 502 for reducing, for dampening and/or for canceling the noise and/or the ambient sounds which may be. heard and/or may be received by the ear 508 and/or the ear drum 512. The microphone 514 and/or the transducer 10 may be connected to, may be attached to and/or may be in communication with an electronic circuit 520 (hereinafter “the circuit 520”). The circuit 520 may be located inside the headphone 500. The circuit 520 may have a first attenuator 522, a summing block 524, a headphone amplifier 526, a filter 528, a microphone amplifier 530 and/or a second attenuator 532.

The microphone 514 may identify, may determine and/or may detect the sound pressure P1 inside the cavity 510 between the diaphragm 12 of the transducer 10 and the eardrum 512. As a result, the microphone 514 may produce and/or may transmit an electrical signal (hereinafter “the signal”) based on, corresponding to and/or representative of a sound wave of the noise and/or the ambient sounds. The noise and/or the ambient sounds may be produced by, may be transmitted from and/or may be generated by one or more external sources which may be remote with respect to the headphone 500. The signal may represent, may be based on and/or may correspond to the noise and/or the ambient sounds which may be inside the cavity 510 from the one or more external sources.

The signal from the microphone 514 may be transmitted and/or may be sent to the circuit 520 inside the headphone 500. The signal from the microphone 514 may be corrected and/or may be adjusted by the filter 528 of the electrical circuit 520. The filter 528 may provide corrections to the signal for reducing the noise and/or the ambient sounds and/or may compensate the signal for response distortion. The response distortion may be imposed on the signal by the transducer 10, the ear cavity 510 and/or the microphone 514. At higher frequencies of the noise and/or the ambient sounds, the cavity 510 between the transducer 10 and the eardrum 512 may exhibit distributed resonances. The microphone 514 may exhibit peaks and/or irregularities for frequencies above a range between, for example, two kHz and three kHz. The filter 528 may correct the peaks and/or the irregularities from the microphone 514 to increase a stability of the headphone 500 over higher frequencies and/or over lower frequencies.

A dampening cover 534 (hereinafter “the cover 534”) may be connected to, may be attached to and/or may cover the microphone 514 inside the ear cup 502 of the headphone 500. The cover 534 may be made from, for example, an acoustically resistive material and/or the like. The cover 534 may be, for example, an acoustic low pass filter which may provide necessary attenuation above a target frequency by an acoustical means and/or may reduce a complexity of a design for the filter 528. The filter 528 may have a lower phase distortion than a phase distortion of an electronic filter (not shown in the figures) to improve stability of a feedback loop of the headphone 500.

The signal from the microphone 514 may be amplified by and/or may be inverted by the microphone amplifier 530 of the circuit 520. The signal may be transmitted from the microphone amplifier 530 to the second attenuator 532 for delivery to the summing block 524. An input signal may pass through the first attenuator 522 for delivery to the summing block 524 for combination with the signal from the microphone 514. The input signal may be, for example, frequency dependent from the noise, the ambient sounds and/or the signal from the microphone 514. As a result, a combined signal of the input signal and of the signal from the microphone 514 may have a noise compensation signal and/or an anti-noise sound wave. The noise compensation signal and/or the anti-noise sound wave may be the opposite polarity of the sound wave for the noise and/or the ambient sounds.

The combined signal may be passed through and/or may be transmitted to the headphone amplifier 526. As a result, the combined signal may be reproduced in, may be generated in and/or may be transmitted to the cavity 510 between the headphone 500 and the ear drum 512 via the transducer 10. The noise compensation signal and/or the anti-noise sound wave may be combined and/or may be added to the sound wave of the noise and/or of' the ambient noise in the cavity 510 to reduce, to cancel and/or to dampen the noise and/or the ambient sounds which may be received by the ear drum 512 of the user.

The ear cushion 506 may have an outer portion 536 and/or an inner portion 538 for attaching and/or for connecting the headphone 500 to the ear 508 of the user. The ear 508 may be inserted between the ear cushion 506 and the ear cup 502 to attach the headphone 500 to the ear 508 of the user. As a result, the outer portion 536 may be pressed against, may abut and/or may contact a head 540 of the user. The outer portion 536 of the ear cushion 506 may be made from an acoustically isolating material to prevent air leakage from the cavity 510 of the headphone 500. The acoustically isolating material may be, for example, leather, vinyl and/or the like. The internal portion 538 of the ear cushion 506 may be adjacent to the cavity 510 and/or the ear drum 512 and/or may be made from an acoustically resistive material. The acoustically resistive material may be, for example, a fabric material, a foam material and/or the like. The ear cushion 506 may increase a dampening of the cavity 510 and/or may reduce irregularities for the headphone 500 in response to one or more frequencies. It should be understood that the acoustically isolating material and/or the acoustically resistive material may be any acoustically isolating material and/or any acoustically resistive material, respectively, as known to one of ordinary skill in the art.

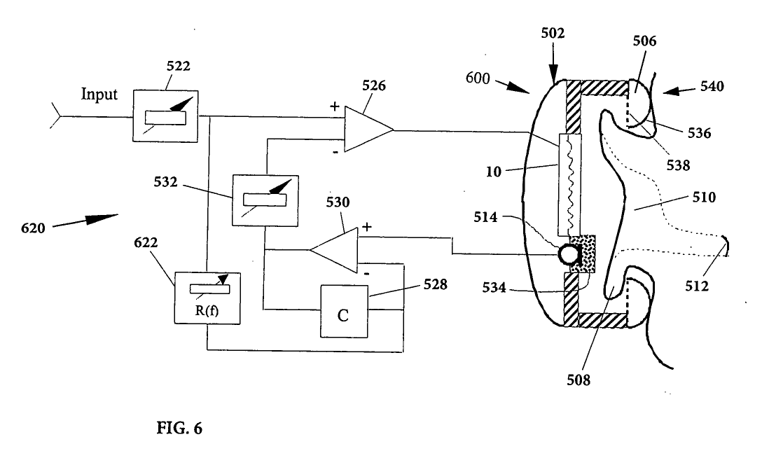

FIG. 6 illustrates the headphone 600 which may be worn on, may be retained to and/or may be connected to the ear 508 of the user in an embodiment of the present invention. The ear 508 may be inserted between and/or may be located between the ear cup 502 and the ear cushion 506. The transducer 10 and/or the microphone 514 may be connected to and/or may be attached to the ear cup 502 of the headphone 600 for reducing, for dampening and/or for canceling the noise and/or the ambient sounds. The transducer 10, the cover 534 and/or the microphone 514 of the headphone 600 may be adjacent to the ear 508 and/or the ear drum 512. The ear cushion 506 with the outer portion 536 and/or the inner portion 538 may be attached to and/or may be connected to the ear cup 502 of the headphone 600. The headphone 600 may have the microphone 514 and/or the transducer 10 inside the ear cup 502. As the headphone 600 may be worn and/or may be retained to the ear 508, the microphone 514 and/or the transducer 10 may reduce, may dampen and/or may cancel the noise and/or ambient sounds in the cavity 510. As a result, the ear drum 512 may not hear and/or may not receive the noise and/or the ambient sounds.

The headphone 600 may be worn on, may be retained to and/or may be connected to the ear 508 via the ear cushion 506 to form the cavity 510 between the ear drum 512 and the microphone 514, the transducer 10 and/or the ear cup 502. The microphone 514 and/or the transducer 10 may be connected to, may be attached to and/or may be in communication with an electronic circuit 620 (hereinafter “the circuit 620”). The circuit 620 may be located inside the headphone 600. The circuit 620 may have the first attenuator 522, the headphone amplifier 526, a frequency dependent controller 622, the filter 528, a microphone amplifier 530 and/or the second attenuator 532. The circuit 620 and/or the transducer 10 may generate and/or may transmit the anti-noise sound wave and/or the noise compensation signal into the cavity 510. As a result, the circuit 620 and/or the transducer 10 may reduce, may dampen and/or may cancel the noise and/or the ambient sounds which may be heard by and/or may be received by the ear 508 and/or the ear drum 512 of the user.

The transducer 10 may reproduce, may generate and/or may transmit an audio signal from a source (not shown in the figures), such as, for example, a stereo receiver, a compact disc player, a digital video disc player, a portable media player, a portable radio receiver, a laptop computer, a cellular phone, a portable compact disc player, a portable MP3 player, a personal data assistant and/or the like. The ear 508 and/or the ear drum 512 may receive and/or may hear the audio signal from the source via the headphone 500. It should be understood that the source of the audio signal may be any source capable of transmitting an audio signal to the transducer 10 as known to one of ordinary skill in the art.

The input signal may pass through and/or may be transmitted through the first attenuator 522 and/or the frequency dependent controller 622 to be combined with the signal from the microphone 514 via the microphone amplifier 530. The filter 528 may correct and/or may filter the combined signal of the input signal and the signal from the microphone 514. The signal from the microphone 514 may be inverted and/or may be combined with the input signal to produce, to generate and/or transmit the combined signal via the second attenuator 532 and/or the headphone amplifier 526. As a result, the microphone amplifier 530 may output and/or may transmit the combined signal which may have the noise compensation signal and/or the anti-noise sound wave for reducing, for dampening and/or for canceling the noise and/or the ambient sounds. The combined signal may be reproduced, may be generated and/or may be transmitted by the transducer 10 of the headphone 600. The noise compensation may be combined with the noise and/or the ambient sounds which may be present in cavity 510 to reduce, to dampen and/or to cancel the noise and/or the ambient sounds. The input signal may not be equalized, may not be boosted and/or may not be compressed via the circuit 620 to increase a quality of audio sound delivered to the ear drum 512 of the user by the headphone 600.

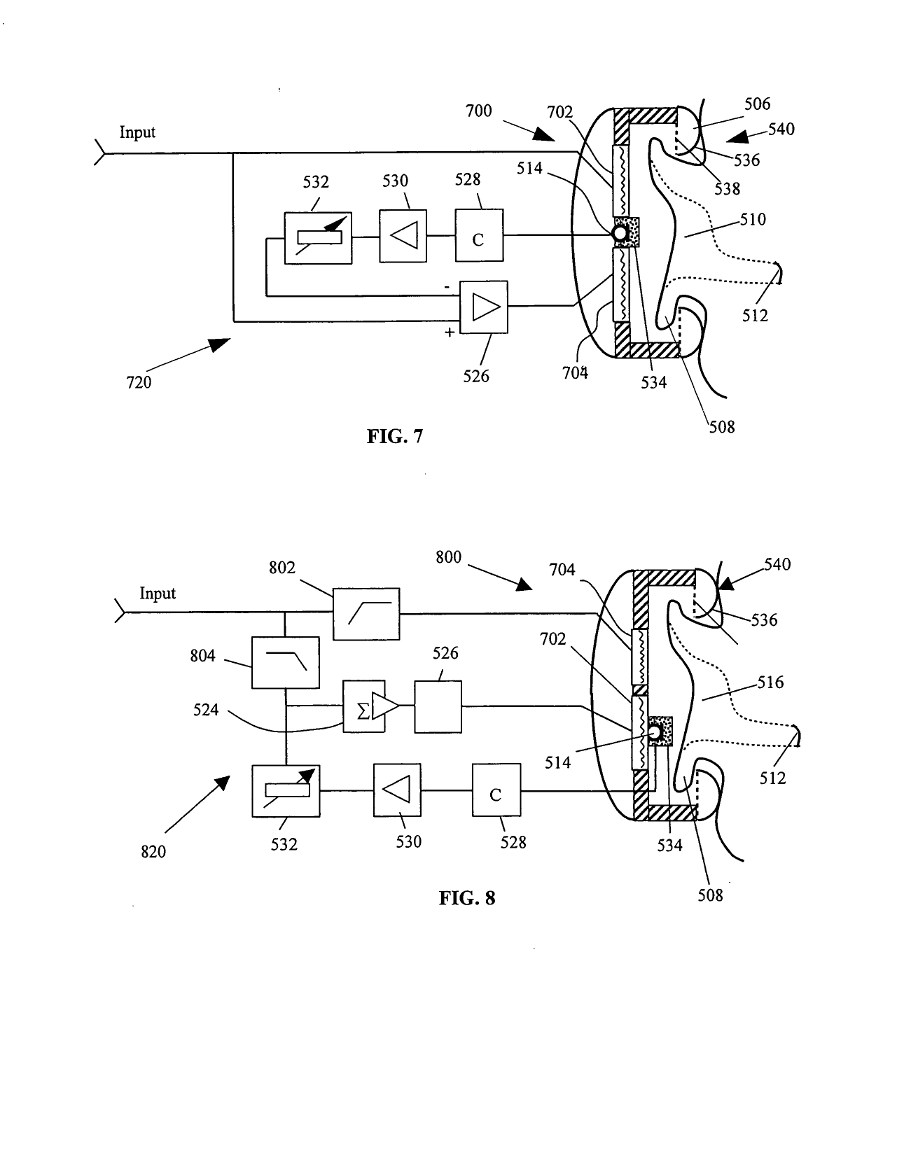

FIG. 7 illustrates the headphone 700 which may be attached to and/or may be connected to the ear 508 of the user in an embodiment of the present invention. The headphone 700 may have a first transducer 702, a second transducer 704 and/or the microphone 514 inside the ear cup 502. The first transducer 702, the second transducer 704 and/or the microphone 514 may be connected to and/or may be attached to the ear cup 502 of the headphone 700 for reducing, for dampening and/or for canceling the noise and/or the ambient sounds. The first transducer 702, the second transducer 704, the cover 534 and/or the microphone 514 may be adjacent to the ear 508 and/or the ear drum 512. The microphone 514 may be located between the first transducer 702 and the second transducer 704 for reducing, for dampening and/or for canceling the noise and/or the ambient sounds within the cavity 510. The first transducer 702 and/or the second transducer 704 of the headphone 700 may have the diaphragm 12 for reducing the noise and/or the ambient sound.

The headphone 700 may have the ear cushion 506 with the outer portion 536 and/or the inner portion 538 which may be attached to and/or connected to the ear cup 502 of the headphone 700. The headphone 700 may be attached to the ear 508 to form the cavity 510 between the ear drum 512 and the microphone 514, the first transducer 702, the second transducer 704 and/or the ear cup 502. The microphone 514, the first transducer 702 and/or the second transducer 704 may be connected to, may be attached to and/or may be in communication with an electronic circuit 720 (hereinafter “the circuit 720”). The circuit 720 may be located inside the headphone 700. The circuit 720 may have the headphone amplifier 526, the filter 528, a microphone amplifier 530 and/or the second attenuator 532. The headphone amplifier 526 may be attached to and/or may be connected to the first transducer 702 and/or the second transducer 704.

The circuit 720 and/or the second transducer 704 may generate and/or may transmit the anti-noise sound wave and/or the noise compensation signal into the cavity 510. As a result, the circuit 720 and/or the second transducer 704 may reduce, may dampen and/or may cancel the noise and/or the ambient sounds which may be heard by and/or may be received by the ear 508 and/or the ear drum 512 of the user. The first transducer 702 may reproduce, may generate and/or may transmit the audio signal of the source to be received by the ear drum 512 of the user. The audio signal from the source may be corrected and/or may be amplified by the source as the audio signal may be transmitted to the first transducer 702. As a result, the ear drum 512 of the user may receive and/or may hear the audio signal from the source via the first transducer 702 in the headphone 700.

The second transducer 704 of the headphone 700 may be used to reduce and/or to cancel the noise and/or the ambient sounds prior to being received by the ear drum 512 of the user. The microphone 514 may be located, for example, equidistantly from the first transducer 702 and the second transducer 704. The microphone 514 may receive an in-phase signal from the first transducer 702 and the second transducer 704 to increase a stability of the feedback loop of the headphone 700 and/or to increase a range of reduction of the noise and/or the ambient sounds. As a result, the headphone 700 may reduce, may dampen and/or may cancel the noise and/or the ambient sounds in the cavity 510 via the noise compensation signal and/or the anti-noise sound wave.

The second transducer 704 may have a dampening cover (not shown in the figures) which may be attached to, may be connected to and/or may cover the second transducer 704 to provide an acoustic filtering for the second transducer 704. As a result, a quality of sound for the audio signal may be increased by the first transducer 702 independently from reducing the noise and/or the ambient sounds via the headphone 700. A battery life of the headphone 700 may be increased since a battery may not be used to amplify the audio signal from the source. The headphone 700 may have a greater level of noise reduction than the headphones 500, 600 because the second transducer 704 may be capable of reproducing signals of a higher amplitude to reduce, to dampen and/or to cancel the noise and/or the ambient sounds.

FIG. 8 illustrates the headphone 800 which may be attached to and/or may be connected to the ear 508 of the user in an embodiment of the present invention. The headphone 800 may have the first transducer 702, the second transducer 704 and/or the microphone 514 inside the ear cup 502 of the headphone 502. The first transducer 702, the second transducer 704 and/or the microphone 514 may be connected to and/or may be attached to the ear cup 502 of the headphone 700 for reducing, for dampening and/or for canceling the noise and/or the ambient sounds. The first transducer 702, the second transducer 704 and/or the microphone 514 may be adjacent to the ear 508 and/or the ear drum 512. The microphone 514 may be located on, may be attached to and/or may be connected to the first transducer 702 for reducing the noise and/or the ambient sounds within the cavity 510. As a result, the microphone 514 may be located between the first transducer 702 and the ear drum 512 of the user. The headphone 800 may have the ear cushion 506 with the outer portion 536 and/or the inner portion 538 which may be attached to and/or connected to the ear cup 502 of the headphone 800. The headphone 800 may be attached to the ear 508 via the ear cushion 506 to form the cavity 510 between the ear drum 512 and the microphone 514, the first transducer 702, the second transducer 704 and/or the ear cup 502.

The microphone 514, the first transducer 702 and/or the second transducer 704 may be connected to, may be attached to and/or may be in communication with an electronic circuit 820 (hereinafter “the circuit 820”). The circuit 820 may be located inside the headphone 800. The circuit 820 may have the summing block 524, the headphone amplifier 526, the filter 528, a microphone amplifier 530 and/or the second attenuator 532. The circuit 820 may have a high pass filter 802 and a low pass filter 804 which may connect the second transducer 704 to the first transducer 702 and/or the microphone 514. The circuit 820 and/or the first transducer 702 may generate and/or may transmit the anti-noise sound wave and/or the-noise compensation signal into the cavity 510. As a result, the circuit 820 and/or the first transducer 702 may reduce, may dampen and/or may cancel the noise and/or the ambient sounds which may be heard by and/or may be received by the ear 508 and/or the ear drum 512 of the user.

The low pass filter 804 and/or the first transducer 702 may reduce, may dampen and/or may cancel a low frequency portion of the noise and/or the ambient sounds which may be present in the cavity of the headphone 800. The headphone 800 may have a crossover point between the high pass filter 802 and the low pass filter 804 at a frequency near, for example, two kHz. The low frequency portion may be used by the headphone 800 to reduce the noise and/or the ambient sounds in the cavity 510 between the ear cup 502 and the ear drum 512 of the user.

The microphone 514 and/or the cover 534 may be placed on and/or may be placed in front of the first transducer 702 to improve a capability of the headphone 800 for reducing, for dampening and/or for canceling the noise and/or the ambient sounds via the noise compensation signal and/or the anti-noise sound wave. The first transducer 702 and/or the second transducer 704 of the headphone 800 may be optimized for reproduction of the low frequencies or the high frequencies via the high pass filter 802 and/or the low pass filter 804. As result, the second transducer 704 may have a size which may be smaller than the first transducer 702 to increase a flexibility of element placement of inside the ear cup 502 of the headphone 800. The second transducer 704 may not reduce, may not dampen and/or may not cancel the noise and/or the ambient sounds to improve reproduction and/or transmission of upper mid-range frequencies and/or of high-range frequencies from the headphone 800 to the ear drum 512 of the user.

The headphones 500, 600, 700, 800 may have the transducer 10 and/or the microphone 514 which may be connected to, may be attached to and/or may be in communication with the electronic circuits 520, 620, 720, 820, respectively. The microphone 512 and/or the electronic circuits 520, 620, 720, 820 may receive, may determine, may identify and/or may detect the noise and/or the ambient sounds within the cavity 510 of the headphones 500, 600, 700, 800. The transducer 10 and/or the electrical circuits 520, 620, 720, 820 may produce, may generate and/or may transmit the noise compensation signal and/or the anti-noise sound wave inside the ear cup 502 to cancel, to dampen and/or to reduce the sound wave of the noise and/or the ambient sounds. As a result, the ear drum 512 may not hear and/or may not receive the noise and/or the ambient sounds from the one or more external sources via the headphones 500, 600, 700, 800. Alternatively, the transducer 10 may transmit the audio signal which may be received by and/or may be heard by the ear 508 of the user. The transducer 10 may have the diaphragm 12 with the circular corrugations 22 and/or the spiral electrical conductors 14 on the first side 50 and/or the second side 51 of the diaphragm 12. The microphone 514 may be covered by, my be attached to and/or may be connected to the cover 534 inside the ear cup 502. The ear cushion 506 may be attached to and/or may be connected to the ear cup 502 for attaching the headphones 500, 600, 700, 800 to the ear 508 of the user. The ear cushion 506 may be made from the acoustically isolating material and/or the acoustically resistive material for reducing, for blocking and/or for damping the noise and/or the ambient sounds.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

We claim:

1. A transducer for reducing a noise in a cavity of an ear cup of a headphone wherein the transducer is connected to the headphone wherein the transducer extends inward with respect to the cavity of the ear cup wherein the headphone is attachable to an ear of a user, the transducer comprising:
a cap having walls defining an interior of the cap; and
a diaphragm having a first side and a second side wherein the first side is opposite to the second side of the diaphragm wherein the first side has first conductors in a first spiral pattern wherein the first side has first gaps between the first conductors wherein the second side has second conductors in a second spiral pattern wherein the second side has second gaps between the second conductors wherein the first gaps of the first side do not coincide with the second gaps of the second side wherein the diaphragm is inserted into the interior of the cap wherein an audio signal is transmitted by the transducer wherein the audio signal reduces the noise.

2. The transducer of claim 1 wherein the first side or the second side of the diaphragm has a thickness less than twenty-five microns.

3. The transducer of claim 1 wherein the diaphragm has a resonant frequency less than two hundred Hertz.

4. The transducer of claim 1 wherein the diaphragm is planar.

5. The transducer of claim 1 further comprising:
circular corrugations formed in the first side and the second side of the diaphragm wherein the circular corrugations are located concentrically on the diaphragm and further wherein the circular corrugations have more than one radii.

6. The transducer of claim 1 further comprising:
an ultrasonic weld located between the first side of the diaphragm and the second side of the diaphragm wherein the first side is connected to the second side via the ultrasonic weld.

7. A headphone for reducing a noise transmitted from a source remote with respect to the headphone wherein a sound wave corresponds to the noise, the headphone comprising:
an ear cup having walls defining a cavity wherein the ear cup is sized to receive an ear of a user wherein the ear of the user is insertable into the ear cup;
a microphone connected to the ear cup wherein the microphone is located within the cavity of the ear cup;
a cover connected to the microphone wherein the cover is located between the microphone and the cavity of the ear cup wherein the cover is an acoustic filter to the microphone wherein the microphone identifies the sound wave of the noise inside the cavity of the ear cup; and
a first transducer connected to the ear cup wherein the first transducer is connected to the microphone wherein the first transducer transmits an audio signal into the cavity of the ear cup wherein the noise in the cavity is reduced by the audio signal.

8. The headphone of claim 7 further comprising:
an ear cushion attached to the walls of the ear cup wherein the ear cup is retained to the ear of the user via the ear cushion and further wherein the ear cushion is made from an acoustically isolating material and an acoustically resistive material.

9. The headphone of claim 7 further comprising:
an electrical circuit located within the ear cup wherein the electrical circuit connects the first transducer and the microphone wherein the electrical circuit identifies the audio signal for reducing the noise.

10. The headphone of claim 7 further comprising:
a second transducer connected to the ear cup wherein the second transducer extends inward with respect to the cavity of the ear cup wherein the second transducer is connected to the first transducer and the microphone.

11. The headphone of claim 7 wherein the audio signal from the transducer has a polarity which is opposite to the sound wave of the noise.

12. The headphone of claim 7 wherein the transducer is a planar ribbon transducer.

13. The headphone of claim 7 further comprising:
a diaphragm having circular corrugations wherein the diaphragm is located inside the first transducer.

14. A method for reducing a noise wherein the noise is transmitted from a source which is remote with respect to an ear of a user wherein a sound wave corresponds to the noise, the method comprising the steps of:
providing a headphone sized to receive the ear of the user wherein the headphone has walls defining a cavity wherein a planar ribbon transducer is connected to the headphone wherein the planar ribbon transducer wherein the planar ribbon transducer has a diaphragm;
identifying the sound wave of the noise; and
transmitting an anti-noise sound wave into the cavity of the headphone via the planar ribbon transducer wherein the anti-noise sound wave has a polarity which is opposite to the sound wave of the noise.

15. The method of claim 14 further comprising the step of:
canceling the noise via the anti-noise sound wave.

16. The method of claim 14 further comprising the step of:
inserting the ear of the user into the headphone wherein the cavity of the headphone is adjacent to the ear of the user.

17. The method of claim 14 further comprising the step of:
connecting an electrical circuit to the planar ribbon transducer wherein the electrical circuit determines the anti-noise sound wave.

18. The method of claim 14 further comprising the step of:
forming a spiral pattern on a side of the diaphragm of the planar ribbon transducer.

19. The method of claim 14 further comprising the step of:
attaching a microphone to the ear cup of the headphone wherein the microphone receives the sound wave of the noise.

20. The method of claim 14 further comprising the step of:
transmitting an audio sound to the ear of the user via the transducer of the headphone.

21. A headphone for reducing a noise transmitted from a source wherein the source is remote with respect to the headphone wherein a sound wave corresponds to the noise, the headphone comprising:
an ear cup having walls defining a cavity wherein the ear cup is sized to receive an ear of a user wherein the noise is transmitted into the cavity of the ear cup;
means for identifying the sound wave of the noise wherein the means for identifying the sound wave connects to the ear cup;
means for filtering the sound wave of the noise inside the cavity of the ear cup wherein the means for filtering the sound wave covers the means for identifying the sound wave of the noise; and
means for generating an audio signal within the cavity of the ear cup wherein the means for generating an audio signal is in communication with the means for identifying the sound wave wherein the audio signal reduces the noise.

22. The headphone of claim 21 further comprising:
an electrical circuit connecting the means for identifying the sound wave of the noise to the means for generating the audio signal within the cavity of the ear cup wherein the electrical circuit is located within the ear cup.

23. The headphone of claim 21 further comprising:
means for retaining the ear cup to the ear of the user wherein means for retaining the ear cup is attached to the walls of the ear cup.

24. The headphone of claim 21 further comprising:
an ear cushion attached to the walls of the ear cup wherein the ear cushion is made from an acoustically isolating material and an acoustically resistive material.

25. The headphone of claim 21 further comprising:
a planar ribbon transducer attached to ear cup wherein the planar ribbon transducer is connected to the means for identifying the sound wave of the noise.

26. The headphone of claim 21 wherein the means for filtering the sound wave of the noise inside the cavity of the ear cup is made from a sound absorbing material.

27. The headphone of claim 21 further comprising:
a diaphragm having circular corrugations wherein the diaphragm is connected to the ear cup and the means for generating an audio signal within the cavity of the ear cup.
